(19) United States
(12) Patent Application Publication
(10) Pub. No.: US 2024/0392149 A1
(43) Pub. Date: Nov. 28, 2024

(54) Ink Jet Ink Composition

(71) Applicant: SEIKO EPSON CORPORATION, Tokyo (JP)

(72) Inventors: Hisashi OKAMURA, Shiojiri (JP); Hidehiko KOMATSU, Chino (JP)

(21) Appl. No.: 18/670,766

(22) Filed: May 22, 2024

(30) Foreign Application Priority Data
May 24, 2023 (JP) 2023-085218

(51) Int. Cl. C09D 11/328; C09D 11/36; C09D 11/38

(52) U.S. Cl. CPC C09D 11/328; C09D 11/36; C09D 11/38

(57) ABSTRACT

An ink jet ink composition contains a red coloring material having a monochlorotriazine group and an azo bond, at least one selected from the group consisting of a compound represented by Formula (1) below and a compound represented by Formula (2) below, a water-soluble organic solvent, and water. In Formula (1) and Formula (2), Xs are each independently H, Na, K, or Li:

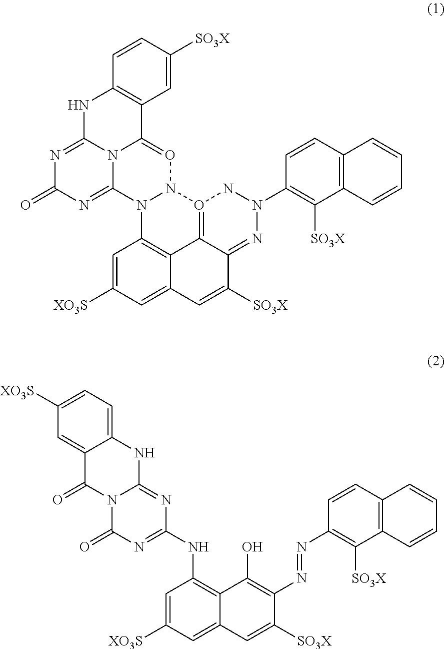

The present application is based on, and claims priority from JP Application Serial Number 2023-085218, filed May 24, 2023, the disclosure of which is hereby incorporated by reference herein in its entirety.

### BACKGROUND

### 1. Technical Field

The present disclosure relates to an ink jet ink composition.

### 2. Related Art

The ink jet method is, not only image recording on recording media, is also tried to be used for textile printing on fabrics, and various kinds of ink compositions for ink jet textile printing are being considered.

For example, JP A-2018-150492 describes an ink composition containing C.I. Reactive Red 31 and C.I. Reactive Red 245 as colorants, the ink composition having a content ratio between C.I. Reactive Red 31 and C.I. Reactive Red 245 contained in the total mass of the ink composition of 8:2 to 1:1 on a mass basis.

The above ink composition is required to make a textile printed product to be obtained have excellent color developing properties and fastness.

### SUMMARY

The present disclosure is an ink jet ink composition containing a red coloring material having a monochlorotriazine group and an azo bond, at least one selected from the group consisting of a compound represented by Formula (1) below and a compound represented by Formula (2) below, a water-soluble organic solvent, and water:

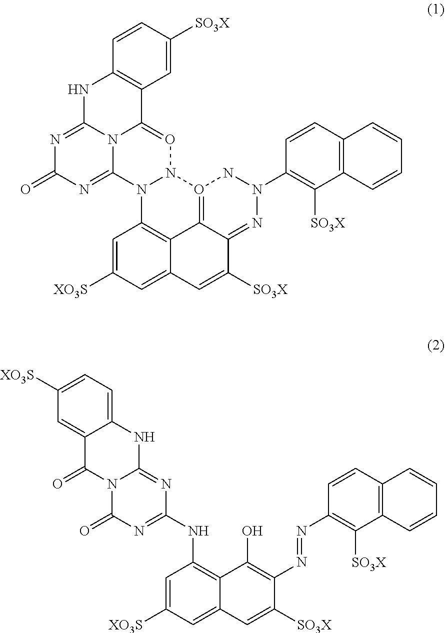

where in Formula (1) and Formula (2), Xs are each independently H, Na, K, or Li.

### BRIEF DESCRIPTION OF THE DRAWINGS

FIG. 1 is a table showing results of examples.

FIG. 2 is a table showing results of the examples.

### DESCRIPTION OF EMBODIMENTS

The following describes an embodiment of the present disclosure (hereinafter, referred to as the “present embodiment”) in detail. The present disclosure is not limited to this, and various modifications can be made without departing from the gist thereof.

### 1. Ink Jet Ink Composition

An ink jet ink composition of the present embodiment (hereinafter, also referred to as the “ink composition”) contains a red coloring material having a monochlorotriazine group and an azo bond, at least one selected from the group consisting of a compound represented by Formula (1) below and a compound represented by Formula (2) below, a water-soluble organic solvent, and water:

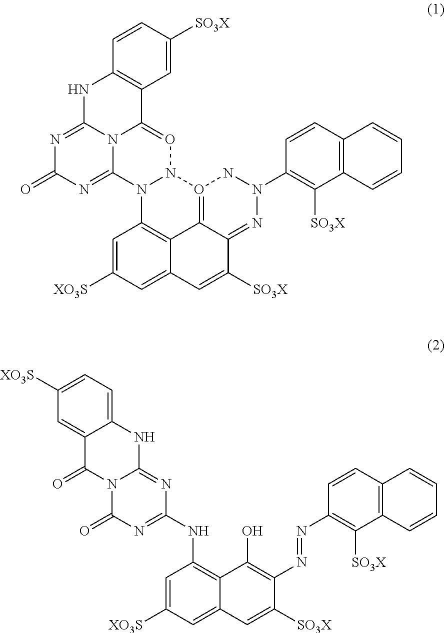

In Formula (1) and Formula (2), Xs are each independently H (a hydrogen atom), Na (a sodium atom), K (a potassium atom), or Li (a lithium atom).

The ink composition of the present embodiment contains the above configuration and thereby makes a textile printed product to be obtained have excellent color developing properties and fastness. The following describes the components contained in the ink composition.

### 1.1. Coloring Material

The ink composition contains the red coloring material having a monochlorotriazine group and an azo bond. This can improve the color developing properties of the textile printed product to be obtained. The monochlorotriazine group is specifically represented by Formula (m) below:

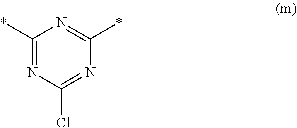 [SMILES: *c1nc(*)nc(Cl)n1]

In Formula (m), * represents bonding positions.

Examples of the red coloring material include, among red reactive dyes such as C.I. Reactive Red 1,3, 3:1, 4, 13, 14, 17, 19, 21, 22, 23, 24, 24:1, 25, 26, 29, 31, 32, 35, 37, 40, 41, 43, 44, 45, 46, 49, 55, 60, 66, 74, 79, 96, 97, 108, 141, 180, 218, 226, and 245, ones having a monochlorotriazine group and an azo bond. Among the above ones, from the viewpoint of having excellent color developing properties of the textile printed product to be obtained, C.I. Reactive Red 31 is preferred as the red coloring material.

As the red coloring material, one may be used singly or two or more may be used in combination.

The content of the red coloring material is preferably 1.0% by mass or more and 50.0% by mass or less with respect to the total amount of the ink composition. By the content of the red coloring material being 1.0% by mass or more with respect to the total amount of the ink composition, the textile printed product to be obtained has excellent color developing properties. From the above viewpoint, the content of the red coloring material is more preferably 3.0% by mass or more and even more preferably 4.0% by mass or more with respect to the total amount of the ink composition. By the content of the red coloring material being 50.0% by mass or less with respect to the total amount of the ink composition, the textile printed product to be obtained has excellent fastness. From the above viewpoint, the content of the red coloring material is more preferably 40.0% by mass or less and even more preferably 30.0% by mass or less with respect to the total amount of the ink composition.

### 1.2. Compound Represented by Formula (1) and Compound Represented by Formula (2)

The ink composition contains at least one selected from the group consisting of the compound represented by Formula (1) below and the compound represented by Formula (2) below. This can improve the fastness of the textile printed product to be obtained.

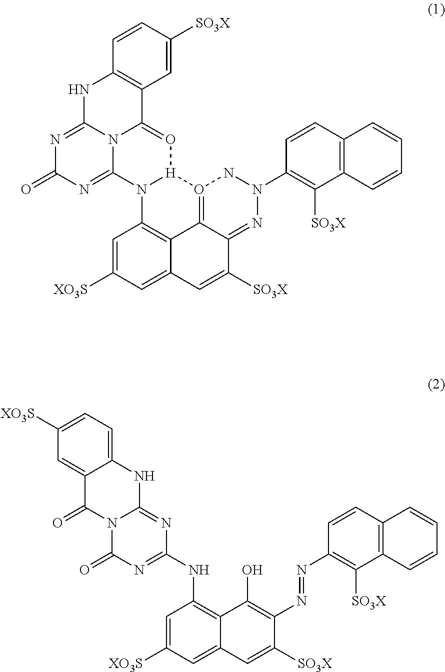

In Formula (1) and Formula (2), Xs are each independently H, Na, K, or Li. At least one of Xs is preferably H. All Xs are more preferably H. This can produce the effect by the present disclosure more effectively and surely.

From the viewpoint of producing the effect by the present disclosure more effectively and surely, the content of the compound represented by Formula (1) is preferably 0.001% by mass or more and 5.0% by mass or less, more preferably 0.005% by mass or more and 4.0% by mass or less, and even more preferably 0.01% by mass or more and 2.0% by mass or less with respect to the total amount of the ink composition.

From the viewpoint of producing the effect by the present disclosure more effectively and surely, the content of the compound represented by Formula (2) is preferably 0.001% by mass or more and 5.0% by mass or less, more preferably 0.005% by mass or more and 4.0% by mass or less, and even more preferably 0.01% by mass or more and 2.0% by mass or less with respect to the total amount of the ink composition.

The ink composition of the present embodiment preferably satisfies a condition represented by Expression (V-1) below:

$$( A + B ) \leq 5 \qquad ( V - 1 )$$

where in Expression (V-1), A is the content [% by mass] of the compound represented by Formula (1) above with respect to the total amount of the ink composition, and B is the content [% by mass] of the compound represented by Formula (2) above with respect to the total amount of the ink composition.

Expression (V-1) represents that the total content of the compound represented by Formula (1) and the compound represented by Formula (2) is 5.0% by mass or less with respect to the total amount of the ink composition. From the viewpoint of producing the effect by the present disclosure more effectively and surely, the total content (A+B) of the compound represented by Formula (1) and the compound represented by Formula (2) is preferably 3.0% by mass or less and more preferably 1.0% by mass or less with respect to the total amount of the ink composition.

From the viewpoint of producing the effect by the present disclosure more effectively and surely, the total content (A+B) of the compound represented by Formula (1) and the compound represented by Formula (2) may be 0.001% by mass or more, is preferably 0.005% by mass or more, and more preferably 0.01% by mass or more with respect to the total amount of the ink composition.

The ink composition of the present embodiment preferably satisfies a condition represented by Expression (V-2) below:

$$5 \leq c / ( A + B ) \leq 3,000 \qquad ( V - 2 )$$

where in Expression (V-2), A is the content [% by mass] of the compound represented by Formula (1) above with respect to the total amount of the ink composition, B is the content [% by mass] of the compound represented by Formula (2) above with respect to the total amount of the ink composition, and C is the content [% by mass] of the red coloring material with respect to the total amount of the ink composition.

Expression (V-2) represent that the ratio (C/(A+B) of the content C of the red coloring material to the total content (A+B) of the compound represented by Formula (1) above and the compound represented by Formula (2) above is 5 or more and 3,000 or less. (C/(A+B) is more preferably 10 or more, even more preferably 15 or more, and particularly preferably 20 or more. (C/(A+B) is more preferably 2,000 or less and even more preferably 1,000 or less.

### 1.3. Water-Soluble Organic Solvent (Penetrant)

The ink composition contains a penetrant such as a water-soluble organic solvent. This improves the ejection stability of the ink composition. As the penetrant, one may be used singly or two or more may be used in combination.

The penetrant is only required to be an organic compound showing solubility to water. For example, an organic solvent having a solubility to water at 25° C. of 1 g/100 g of water or more can be suitably used as the water-soluble organic solvent.

Examples of the water-soluble organic solvent include alcohols such as monohydric alcohols and polyhydric alcohols; glycol ethers; lactam-based compounds having a lactam structure in the molecule; N, N-dimethylformamide, N, N-dimethylacetamide, dimethylsulfoxide, cyclohexanone, and acetonitrile. Among the above, the water-soluble organic solvent preferably contains the lactam-based compounds.

Examples of the monohydric alcohols include alkyl alcohols having a C₃₋₂₀ linear or branched alkyl group.

Examples of the polyhydric alcohols include alkanediols such as ethylene glycol, propylene glycol, 1,2-propanediol, 1,3-propanediol, 1,2-butanediol, 1,3-butanediol, 1,2-pentanediol, 1,3-pentanediol, 1,4-butanediol, 2,3-butanediol, 3-methyl-1,3-butanediol, 1,5-pentanediol, 2-methyl-2,4-pentanediol, 3-methyl-1,5-pentanediol, 1,2-hexanediol, 1,6-hexanediol, 1,2-octanediol, 2-methyl-1,3-propanediol, 2,2-dimethyl-1,3-propanediol, and 2-ethyl-1,3-hexanediol; dihydric alcohols such as diethylene glycol, triethylene glycol, tetraethylene glycol, and dipropylene glycol; and trihydric alcohols such as trimethylolpropane and glycerin.

Examples of the glycol ethers include alkylene glycol monoethers and alkylene glycol diethers.

Examples of the alkylene glycol monoethers include ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol monohexyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, dipropylene glycol monomethyl ether, and dipropylene glycol monoethyl ether.

Examples of the alkylene glycol diethers include ethylene glycol dimethyl ether, ethylene glycol diethyl ether, ethylene glycol dibutyl ether, diethylene glycol dimethyl ether, diethylene glycol diethyl ether, diethylene glycol ethylmethyl ether, diethylene glycol dibutyl ether, diethylene glycol butylmethyl ether, triethylene glycol dimethyl ether, triethylene glycol diethyl ether, triethylene glycol dibutyl ether, triethylene glycol butylmethyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, and dipropylene glycol diethyl ether.

Examples of the lactam-based compounds include 2-pyrrolidone, N-hydroxyethyl-2-pyrrolidone, ε-caprolactam, 2-azetidinone, 2-piperidone, 4-ethyl-2-azetidinone, N-methyl-2-pyrrolidone, γ-butyrolactone, and 3-amino-2-piperidone.

As the lactam-based compounds, at least one selected from the group consisting of 2-pyrrolidone, N-hydroxyethyl-2-pyrrolidone, and ε-caprolactam is preferably contained.

When the ink composition contains the lactam-based compounds as the water-soluble organic solvent, the content of the lactam-based compounds is preferably 1.0% by mass or more and 30.0% by mass or less and more preferably 5.0% by mass or more and 20.0% by mass or less with respect to the total amount of the ink composition.

The content of the water-soluble organic solvent, which is not particularly limited, is preferably 1.0% by mass or more and 50.0% by mass or less, more preferably 1.5% by mass or more and 40.0% by mass or less, even more preferably 1.5% by mass or more and 30.0% by mass or less, and still even more preferably 2.0% by mass or more and 20.0% by mass or less with respect to the total amount of the ink composition from the viewpoint of ejection stability.

### 1.4. Water

The ink composition contains water. Examples of the water include waters with ionic impurities removed to the utmost, such as ion exchanged water, ultrafiltered water, reverse osmotic water, pure water such as distilled water, and ultrapure water. Waters sterilized with UV irradiation, addition of hydrogen peroxide, or the like are preferred because the occurrence of mold and bacteria can be prevented when a processing liquid composition is stored for a long term.

The content of the water is preferably 30% by mass or more and 80% by mass or less with respect to the total amount of the ink composition. By setting the content of the water to be within the above range, the viscosity of the ink composition can be prevented from increasing.

### 1.5. Surfactant

The ink composition may contain a surfactant. The surfactant has the function of reducing the surface tension of the ink composition to adjust wettability against a recording medium. Examples of the surfactant include acetylene glycol-based surfactants, silicone-based surfactants, and fluorine-based surfactants.

Examples of the acetylene glycol-based surfactants include Surfynol (registered trademark) 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (manufactured by Nissin Chemical Co., Ltd.); Olfine (registered trademark) B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (manufactured by Nissin Chemical Co., Ltd.); and Acetylenol (registered trademark) E00, E00P, E40, and E100 (manufactured by Kawaken Fine Chemicals Co., Ltd.).

Examples of the silicone-based surfactants include polysiloxane-based compounds such as polyether-modified organosiloxanes. Examples of commercially available products of the polyether-modified organosiloxanes include BYK-306, BYK-307, BYK-333, BYK-341, BYK-345, BYK-346, and BYK-348 (manufactured by BYK-Chemie Japan K.K.); and KF-351A, KF-352A, KF-353, KF-354L, KF-355A, KF-615A, KF-945, KF-640, KF-642, KF-643, KF-6004, KF-6020, X-22-4515, KF-6011, KF-6012, KF-6015, and KF-6017 (manufactured by Shin-Etsu Chemical Co., Ltd.).

Examples of the fluorine-based surfactants include fluorine-modified polymers. More specific examples include BYK-340 (manufactured by BYK-Chemie Japan K.K.).

As the surfactant, one may be used singly or two or more may be used in combination.

Because of having even better color developing properties, lightfastness, and clogging recoverability, the content of the surfactant is preferably 0.01% by mass or more and 10% by mass or less, more preferably 0.05% by mass or more and 5.0% by mass or less, and even more preferably 0.1% by mass or more and 1.0% by mass or less with respect to the total amount of the ink composition.

### 1.6. Antiseptic

The ink composition may contain an antiseptic. The antiseptic functions also as a mold inhibitor. As the antiseptic, one may be used singly or two or more may be used in combination.

Examples of such an antiseptic include sodium benzoate, sodium pentachlorophenol, sodium 2-pyridinethiol-1-oxide, sodium sorbate, sodium dehydroacetate, 1,2-dibenzoisothiazolin-3-one, and 4-chloro-3-methylphenol (Preventol CMK from Bayer and the like). As the antiseptic, commercially available products can also be used. Examples of the commercially available products include Proxel (registered trademark) series CRL, BND, GXL, XL-2, and TN (product names, Lonza Japan Ltd.) and Preventol (registered trademark) CMK (Bayer).

Because of having even better color developing properties, lightfastness, and clogging recoverability, the content of the antiseptic is preferably 0.01% by mass or more and 10% by mass or less, more preferably 0.03% by mass or more and 5.0% by mass or less, and even more preferably 0.05% by mass or more and 1.0% by mass or less with respect to the total amount of the ink composition.

### 1.7. Other Components

The ink composition may contain various additives that can be normally used in ink compositions, such as dissolution aids, viscosity adjusting agents, pH adjusting agents, antioxidants, UV absorbers, oxygen absorbers, anticorrosive agents, corrosion inhibitors, and chelating agents. As the additives, one may be used singly or two or more may be used in combination.

Because of having even better color developing properties, lightfastness, and clogging recoverability, the content of the additives is preferably 0.01% by mass or more and 10% by mass or less in total with respect to the total amount of the ink composition.

### 2. Method for Producing Ink Composition

The ink composition can be prepared by mixing together the components described above in any order and performing filtration and the like as needed to remove impurities, foreign matter, and the like. As the method for mixing together the components, a method of successively adding the components to a container including a stirrer such as a mechanical stirrer or a magnetic stirrer and stirring and mixing together them is used. Examples of the method of filtration include centrifugal filtration and filter filtration.

### 3. Method of Recording

The method of ink jet recording according to the present embodiment is performed using the ink jet ink composition. Specifically, the method of ink jet recording includes a step of ejecting the ink composition from an ink jet head and causing it to adhered to a recording medium.

The following describes the recording medium, an ink jet recording apparatus that can be used in the method of recording, and steps.

### 3.1. Recording Medium

The recording medium, which is not particularly limited, may be one having a recording face absorbing liquid or one not having the recording face absorbing liquid. Examples of such a recording medium include papers, films, fabrics, metals, glasses, and polymers. From the viewpoint of producing the effect by the present disclosure more effectively and surely, the recording medium is preferably a fabric. When the recording medium is the fabric, the method of ink jet recording is a method of textile printing by ink jet.

Examples of the yarns of the fabric include natural fibers such as cotton, hemp, wool, and silk; synthetic fibers such as polypropylene, polyester, acetate, triacetate, polyamide, and polyurethane; and biodegradable fibers such as polylactic acid, which may be mixed fibers of these. The fabric may be obtained by making the fibers described above into any form of a woven fabric, a knitted fabric, a nonwoven fabric, and the like or obtained by performing mixed weaving or the like thereon. Because even better color developing properties can be obtained, the yarn of the fabric is preferably cotton and silk and more preferably silk.

### 3.2. Ink Jet Recording Apparatus

As the ink jet recording apparatus, either a serial type one or a line type one can be used. An ink jet head is installed in the ink jet recording apparatus of these types. This ink jet recording apparatus ejects droplets of the ink composition from a nozzle hole of the ink jet head with certain timing and with a certain volume (mass) while changing the relative positional relation between the recording medium and the ink jet head. By causing the ejected ink composition to adhere to the recording medium, a certain image can be formed.

For the ink jet recording apparatus, for example, known components such as a drying unit, a roll unit, and a winding device can be freely employed. The ink jet recording apparatus may have, for example, transportation means for transporting the recording medium, image layer forming means for recording images using the ink composition, drying means, overall drying means for performing heating of the recording face and air blowing thereon, and the like.

The transportation means includes a roller, for example. In that case, a plurality of rollers may be included. Examples of other means include a method of causing the recording medium to be in close contact with and to stick to a rubber belt or the like to transport the recording medium. The position at which the transportation means is provided and the number of the transportation means can be freely employed so long as the recording medium can be transported. The transportation means may include a roll mechanism, a tray, various platens, and the like.

The image layer forming means ejects the ink composition to the recording face of the recording medium to record an imaging layer. The image layer forming means includes an ink jet head including nozzles, and a nozzle row is assigned to each certain composition.

The drying means can be used for heating and drying the image layer formed on the recording face and/or removing volatile components on the recording medium. The drying means may be provided at any position considering the timing of the adhesion step, a transportation path for the recording medium, and the like. Examples of the drying means include a method of applying heat to the recording medium by platen heating or the like, a method of blowing air to the image on the recording medium, and a method of combining them together. Specifically, examples of means used for these methods include forced-air heating, radiation heating, conduction heating, high-frequency heating, and microwave heating.

### 3.3. Steps of Method of Recording

The step for causing the ink composition to adhere to the recording medium can be performed using the ink jet recording apparatus. That is, by filling the ink composition in the ink jet head so that the ink composition can be ejected from a certain nozzle and in that state ejecting the ink composition to the recording medium with certain timing, the ink composition can be caused to adhere to the recording medium.

The method of recording may include a step for heating the recording medium as appropriate. For the heating step, for example, when the ink jet recording apparatus is used, the above drying means can be used. Not limited to the ink jet recording apparatus, other drying means may also be used as appropriate. By including the heating step in the method of recording, image blurring is prevented, and images can be fixed more efficiently.

The method of recording may have other steps. Examples of such steps include a step of imparting other compositions and a cleaning step.

In the method of recording, the ink composition according to the present embodiment is used, and thus images having good clogging recoverability and having excellent color developing properties and lightfastness can be recorded.

### EXAMPLES

The following describes the present disclosure more specifically using examples and comparative examples. The present disclosure is not limited by the following examples at all.

### Materials of Ink Composition

The details of components contained in ink compositions are as follows.

### Coloring Materials

RR31: C.I. Reactive Red 31 (a red coloring material having a monochlorotriazine group and an azo bond, a commercially available product)

AR289: C.I. Acid Red 289 (a coloring material not corresponding to the red coloring material having a monochlorotriazine group and an azo bond, a commercially available product)

### Compound Represented by Formula (1)

A-1: a compound represented by Formula (1) in which all Xs in Formula (1) are H Compound Represented by Formula (2)
A-2: a compound represented by Formula (2) in which all Xs in Formula (2) are H

A 15% by mass aqueous solution of C.I. Reactive Red 31 (a commercially available product) was reacted in an acidic condition of pH<2 at 90 to 95° C. for 3 to 4 hours and was collected by filtration to separately obtain A-1 and A-2 by recrystallization.

### Compound Corresponding to Neither Formula (1) Nor Formula (2)

RR245: C.I. Reactive Red 245 (a commercially available product)

### Water-Soluble Organic Solvent (Penetrant)

2-Pyrrolidone
N-Hydroxyethyl-2-pyrrolidone
ε-Caprolactam
Dimethylformamide
Triethylene glycol monobutyl ether
Surfactant

Olfine (registered trademark) PD-002W (product name, Nissin Chemical Co., Ltd.)

### Antiseptic

Proxel (registered trademark) XL-2 (product name, Lonza Japan Ltd.)

### Preparation of Ink Jet Ink Compositions

### Examples 1 to 17 and Comparative Examples 1 to 3

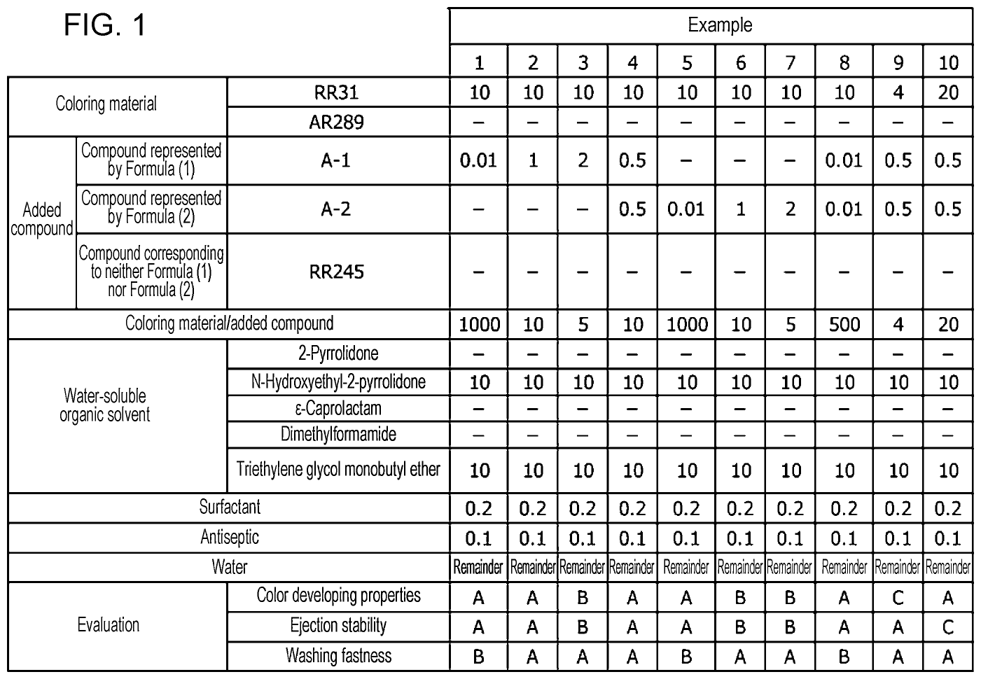

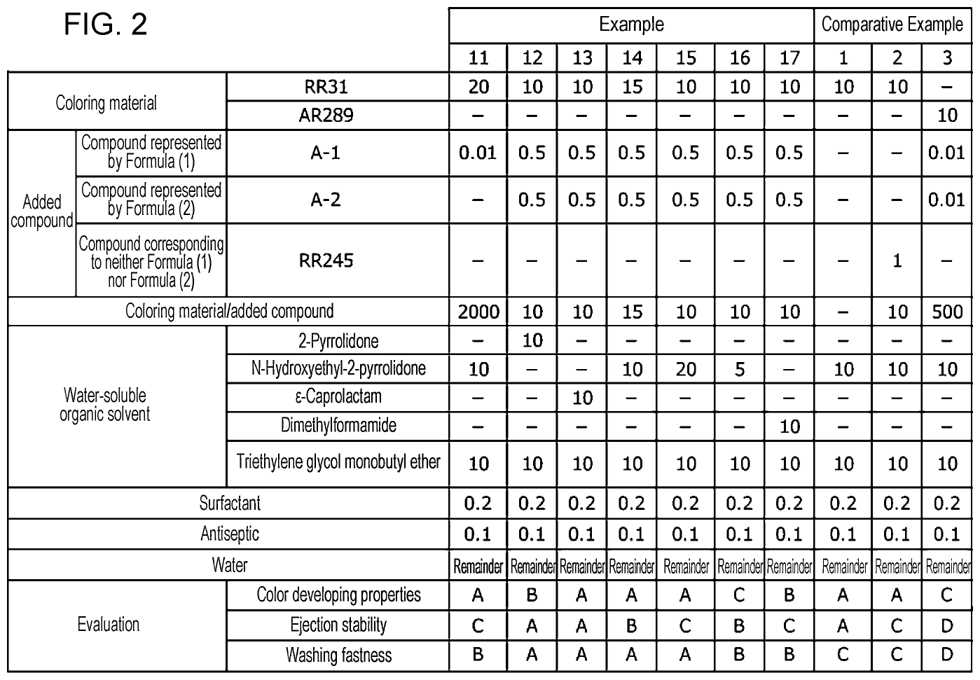

The components were put into a tank for a mixture so as to give the compositions listed in FIG. 1 and FIG. 2 and were mixed together and stirred with a magnetic stirrer for 2 hours. The mixture was then filtered with a membrane filter with a pore size of 5 μm to obtain the ink jet ink compositions according to the examples and the comparative examples. The values in FIG. 1 and FIG. 2 are in terms of % by mass. For the water, ion exchanged water was used, which was added so as to make the mass of each ink 100% by mass.

### Color Developing Properties

As follows, using an ink jet recording apparatus (PX-930G (product name manufactured by Seiko Epson Corporation)), textile printing was performed on a fabric, and color developing properties were evaluated.

Each of the ink compositions of the examples and the comparative examples was filled in an ink cartridge for the recording apparatus. Textile printing was performed on fabrics (cotton and silk) with a resolution of 720 dpi×720 dpi. Color developing properties were evaluated by measuring the OD value of an image with a colorimeter (product name: Spectrolino manufactured by X-Rite, Incorporated). Specifically, based on a measured OD value of M (magenta) component, the color developing properties of the image were evaluated in accordance with the following criteria. Grade C or higher is said to have gained good color developing properties.

### Criteria

A: The OD value was 0.75 or more.
B: The OD value was 0.65 or more and less than 0.75
C: The OD value was 0.50 or more and less than 0.65.
D: The OD value was less than 0.50.

### Ejection Stability

As follows, using an ink jet recording apparatus (PX-H6000 (product name manufactured by Seiko Epson Corporation)), textile printing was performed on a fabric, and ejection stability was evaluated.

Each of the ink compositions of the examples and the comparative examples was filled in an ink cartridge for the recording apparatus. It was made sure that all the nozzles of the ink jet recording apparatus performed ejection normally without any omission or curve. Subsequently, ejection stability after 10 hours of continuous ejection was evaluated in accordance with the following criteria. Grade C or higher is said to have gained ejection stability that meets practical use.

### Criteria

A: All the nozzles performed ejection normally.
B: An omission or curve occurred in greater than 0% and less than 10% nozzles with respect to all the nozzles.
C: An omission or curve occurred in 10% or more and less than 20% nozzles with respect to all the nozzles.
D: An omission or curve occurred in 20% or more nozzles with respect to all the nozzles.

### Washing Fastness

As follows, using an ink jet recording apparatus (PX-H6000 (product name manufactured by Seiko Epson Corporation)), textile printing was performed on a fabric, and washing fastness was evaluated.

Each of the ink compositions of the examples and the comparative examples was poured into each color chamber of an ink cartridge for the recording apparatus, then this was mounted on the recording apparatus, and the ink was filled therein. Subsequently, solid printing was performed on the fabric to prepare a textile printed product in each color. Three types of fabrics, or silk, wool, and a mixed fabric of nylon and urethane, were used.

Next, for the textile printed product obtained by performing steaming processing using a steamer (manufactured by Mathis AG, Steamer Type DHe) in a 102° C. highly humidified condition for 30 minutes, washing fastness was evaluated by a method pursuant to ISO 105-C10: 2006. Grade B or higher is said to have gained good fastness.

The criteria are as follows:

### Criteria

A: Washing fastness was Grade 4 or higher.
B: Washing fastness was Grade 3 or higher and less than Grade 4.
C: Washing fastness was Grade 2 or higher and less than Grade 3.
D: Washing fastness was less than Grade 2.

As shown in FIG. 1 and FIG. 2, the examples, in which the ink compositions containing the red coloring material having a monochlorotriazine group and an azo bond, at least one selected from the group consisting of the compound represented by Formula (1) and the compound represented by Formula (2), the water-soluble organic solvent, and water are used, showed excellent evaluations of color developing properties and washing fastness. Thus, it has been found that the ink composition of the present disclosure makes the textile printed product to be obtained have excellent color developing properties and washing fastness. On the other hand, Comparative Examples 1 and 2, which do not contain at least one selected from the group consisting of the compound represented by Formula (1) and the compound represented by Formula (2), showed poor fastness. Among them, Comparative Example 2, which contains the compound corresponding to neither Formula (1) nor Formula (2), also showed somewhat poor ejection stability. Comparative Example 3, in which the coloring material not corresponding to the red coloring material having a monochlorotriazine group and an azo group is used, showed somewhat poor color developing properties and showed poor ejection stability and washing fastness.

Examples 1, 2, 4, and 5, which satisfy the condition represented by Expression (V-1), showed even better color developing properties and ejection stability than Examples 3 and 7, which do not satisfy the condition represented by Expression (V-1).

Example 13, which contains the lactam-based compound as the water-soluble organic solvent, showed even better color developing properties, ejection stability, and washing fastness than Example 17, which does not contain the lactam-based compound as the water-soluble organic solvent.

What is claimed is:

1. An ink jet ink composition comprising:
a red coloring material having a monochlorotriazine group and an azo bond;
at least one selected from the group consisting of a compound represented by Formula (1) below and a compound represented by Formula (2) below;
a water-soluble organic solvent; and
water: 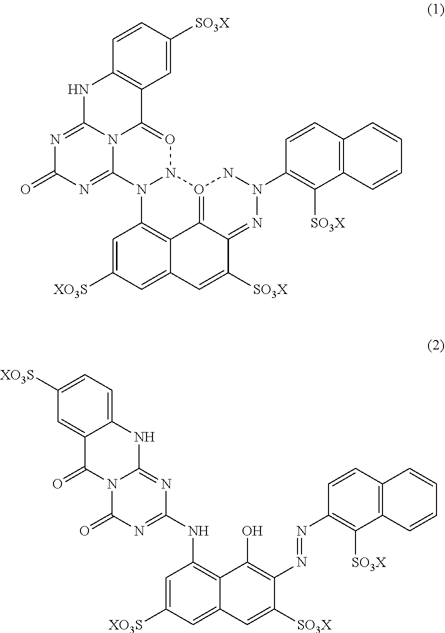
where in Formula (1) and Formula (2), Xs are each independently H, Na, K, or Li.

2. The ink jet ink composition according to claim 1, wherein the red coloring material is C.I. Reactive Red 31.

3. The ink jet ink composition according to claim 1, wherein (A+B)≤5 (V-1)
where in Expression (V-1), A is a content [% by mass] of the compound represented by Formula (1) above with respect to a total amount of the ink jet ink composition, and B is a content [% by mass] of the compound represented by Formula (2) above with respect to the total amount of the ink jet ink composition.

4. The ink jet ink composition according to claim 1, wherein 5≤c/(A+B)≤3,000 (V-2)
where in Expression (V-2), A is a content [% by mass] of the compound represented by Formula (1) above with respect to a total amount of the ink jet ink composition, B is a content [% by mass] of the compound represented by Formula (2) above with respect to the total amount of the ink jet ink composition, and C is a content [% by mass] of the red coloring material with respect to the total amount of the ink jet ink composition.

5. The ink jet ink composition according to claim 1, wherein the water-soluble organic solvent contains a lactam-based compound.

6. The ink jet ink composition according to claim 5, wherein the lactam-based compound contains at least one selected from the group consisting of 2-pyrrolidone, N-hydroxyethyl-2-pyrrolidone, and ε-caprolactam.

7. The ink jet ink composition according to claim 1, wherein a content of the red coloring material is 4.0 by mass or more with respect to a total amount of the ink composition.
